(19) United States
(12) Patent Application Publication
(10) Pub. No.: US 2016/0357371 A1
(43) Pub. Date: Dec. 8, 2016

(54) TERMINAL FOR GENERATING SCHEDULE AND METHOD FOR GENERATING SCHEDULE

(71) Applicant: SOFTSEED INC., Anyang-si (KR)

(72) Inventor: Seung Mi LEE, Incheon (KR)

(21) Appl. No.: 15/240,115

(22) Filed: Aug. 18, 2016

Related U.S. Application Data
(63) Continuation of application No. PCT/KR2015/009315, filed on Sep. 3, 2015.

(30) Foreign Application Priority Data
Nov. 13, 2014 (KR) 10-2014-0158175

(51) Int. Cl. G06F 3/0482; G06Q 10/10; G06F 3/0486

(52) U.S. Cl. CPC G06F 3/0482; G06F 3/0486; G06Q 10/1095; H04M 1/72566

(57) ABSTRACT

Disclosed herein are a schedule management terminal and method. The schedule management terminal includes a display unit, an input unit, and a control unit. The display unit may display a user interface including a period display region, in which a continuous period is divided into intervals, and one or more event buttons. The input unit may receive user input including a selection, a dragging or a dropping for the user interface that is displayed by the display unit. When receiving user input adapted to select a part of the event buttons via the input unit and drag and drop the selected event button on a desired interval of the period display region, the control unit may generate event information corresponding to the selected event button for the desired interval.

### CROSS-REFERENCE TO RELATED APPLICATION

This application is a continuation of International Application No. PCT/KR2015/009315, filed on Sep. 3, 2015, which claims the benefit of the Korean Patent Application No. 10-2014-0158175, filed on Nov. 13, 2014, the contents of which are hereby incorporated by reference in their entirety into this application.

### STATEMENT REGARDING SPONSORED RESEARCH OR DEVELOPMENT

This work was supported by the Starting Growth Technological R&D Program (S2257005) funded by the Small and Medium Business Administration (SMBA, Korea).

### BACKGROUND

1. Technical Field

The present invention relates generally to a schedule generation terminal and method, and more particularly to a schedule generation terminal and method that are capable of facilitating user input, thereby providing a more convenient electronic scheduler.

2. Description of the Related Art

With the recent popularization of smartphones, the number of people who manage their personal schedules using smartphone applications have increased. In order to generate a schedule using a conventional schedule management application, it is necessary to undergo the process of selecting a date and inputting an event in a text form.

In connection with this, Korean Patent Application Publication No. 10-2014-0061190 discloses a technology for a date designation method for the registration of a schedule in a scheduler including a touch screen.

Meanwhile, the above-described related art corresponds to technical information that has been possessed by the present inventor in order to devise the present invention or that has been acquired in the process of devising the present invention, and is not necessarily considered to be a well-known technology that had been known to the public before the filing date of the present invention.

### SUMMARY

In accordance with an aspect of the present embodiments invention, there is provided a terminal for performing a schedule management method. The terminal includes a display unit, an input unit, and a control unit. The display unit may display a user interface including a period display region, in which a continuous period is divided into intervals, and one or more event buttons. The input unit may receive user input including a selection, a dragging or a dropping for the user interface that is displayed by the display unit. When receiving user input adapted to select a part of the event buttons via the input unit and drag and drop the selected event button on a desired interval of the period display region, the control unit may generate event information corresponding to the selected event button for the desired interval.

In accordance with another aspect of the present embodiments invention, there is provided a schedule generation method by which a terminal performs schedule management, the schedule generation method including: generating one or more categories by categorizing one or more event buttons according to desired criteria; displaying a period display region, in which a continuous period is divided into intervals, and the categories; receiving user input adapted to drag and drop a desired one of the one or more event buttons to and on a desired interval of the period display region; and generating event information corresponding to the event button dropped on the desired interval.

In accordance with still another aspect of the present embodiments invention, there is provided a schedule generation method by which a terminal performs schedule management, the schedule generation method including: providing a period display region in which a continuous period is divided into intervals, and a user interface which enables a user to enter a desired event in an empty event button; receiving the desired event for the empty event button from the user via the user interface; receiving user input adapted to drag and drop the empty event button to and on a desired interval of the period display region; and generating information about the received event in the empty event button for the desired interval.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a terminal according to an embodiment of the present invention;

FIG. 2 is a flowchart illustrating a schedule generation method according to an embodiment of the present invention;

FIGS. 3 to 7 are diagrams illustrating examples of schedule generation methods according to embodiments of the present invention; and

FIGS. 8 and 9 are flowcharts illustrating schedule generation methods according to embodiments of the present invention.

### DETAILED DESCRIPTION

Embodiments of the present invention will be described below with reference to the accompanying drawings in order to enable those having ordinary knowledge in the art to which the present invention pertains to easily practice the present invention. However, the present invention may be implemented in different forms, and is not limited to embodiments described herein. Furthermore, in order to clearly illustrate the present invention in the drawings, components and portions unrelated to the following description will be omitted. Throughout the specification, similar reference symbols will be assigned to similar components.

Throughout the specification and the claims, when one component is described as being “connected” to another component, the one component may be “directly connected” to the other component or “electrically connected” to the other component through a third component. Throughout the specification and the claims, unless explicitly described to the contrary, the terms “include” and “comprise” and their variants, such as “includes,” “including,” “comprises” and “comprising,” will be understood to imply the inclusion of described components, not the exclusion of any other components.

The present invention will be described in detail with reference to the accompanying diagrams.

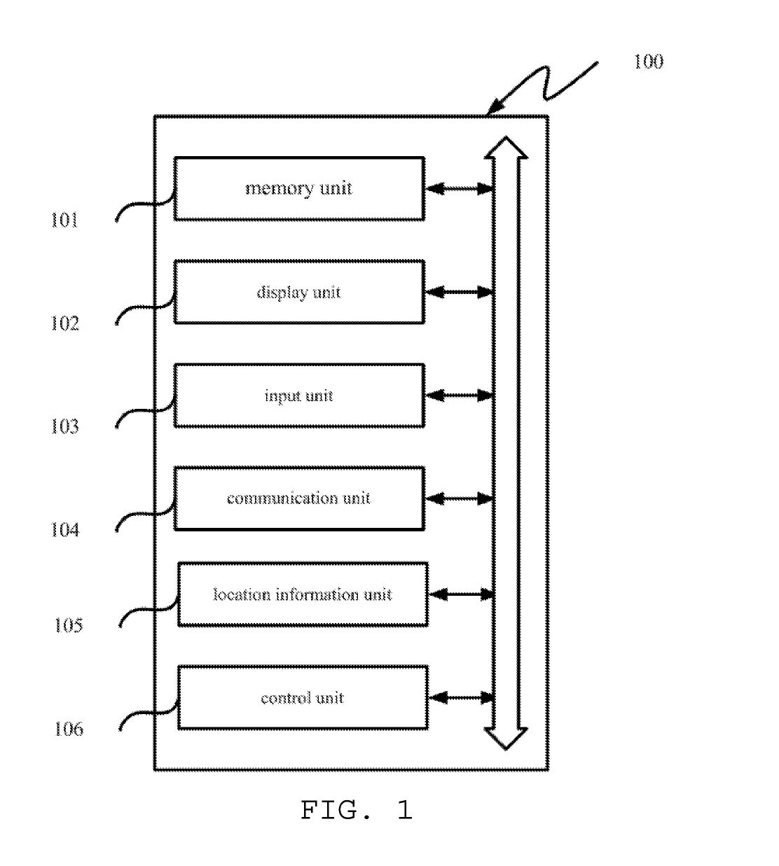

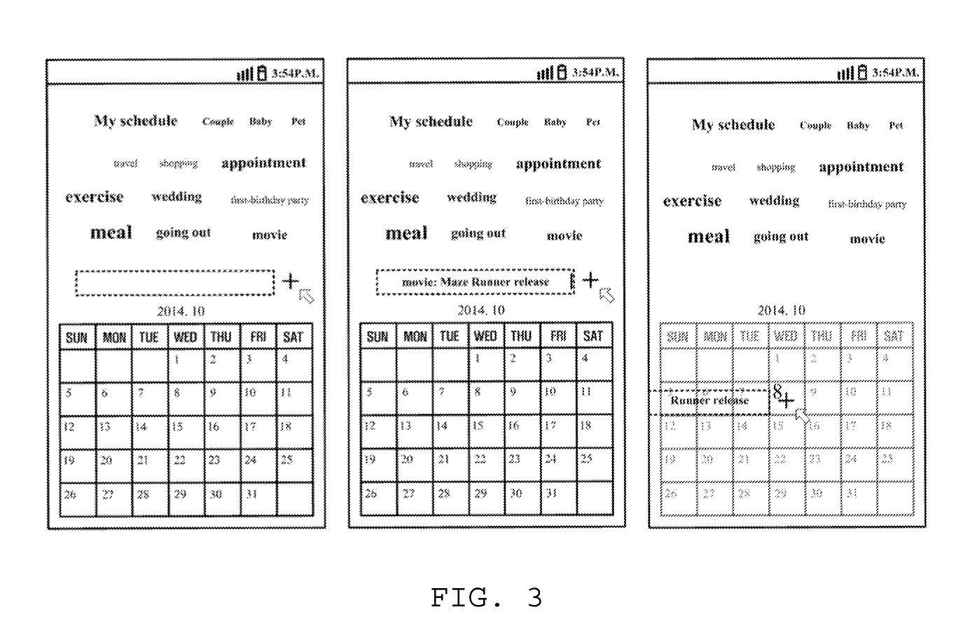

FIG. 1 is a block diagram of a terminal according to an embodiment of the present invention. The present invention is described chiefly based on FIG. 1, and is described with reference to FIGS. 3 to 7, showing embodiments of the present invention, when necessary.

A terminal 100 shown in FIG. 1 is a device for performing a schedule generation method, and may include a memory unit 101, a processor, and a communication unit 104. The processor may include a display unit 102, an input unit 103, a location information unit 105, and a control unit 106.

The memory unit 101 may store a program adapted for operation of the control unit 106, and may store input and output data, for example, a period display region image for the management of a schedule, an event button image, event information generated in response to user input, etc.

The memory unit 101 may include at least one type of storage medium selected among flash memory-type memory, hard disk-type memory, multimedia card micro-type memory, card-type memory (for example, SD or XD memory, or the like), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, a magnetic disk, and an optical disk. The memory unit 101 may be replaced with web storage that performs a storage function over the Internet.

The display unit 102 is intended to generate visual, hearing, or tactile sense-related output for a user, and may include a display means, a sound output means, an alarm means, a haptic means, etc.

The display unit 102 displays information, processed in the terminal 100, via the display means. For example, when a schedule generation application is executed on the terminal 100, the display unit 102 displays a schedule generation-related User Interface (UI) or Graphic User Interface (GUI).

The display means may include at least one of a Liquid Crystal Display (LCD), a Thin Film Transistor-Liquid Crystal Display (TFT LCD), an Organic Light-Emitting Diode (OLED), a flexible display, and a three-dimension (3D) display.

Some of these display means may be configured to be a transparent or light transmission type so that the outside can be viewed therethrough. This may be referred to as a “transparent display.” A representative example of such transparent displays may be a Transparent OLED (TOLED).

The rear structure of the display means may be also configured in a light transmission-type structure. Using this structure, a user may view an object located behind the body of the terminal 100 via an area that is occupied by the body of the terminal 100 of the display unit.

The input unit 103 receives input data generated by a user in order to control the operation of the terminal 100. The input unit 103 may include, for example, a (static pressure or electrostatic) touchpad, a keypad, a dome switch, a jog wheel, and a jog switch. According to an embodiment of the present invention, the input unit 103 receives input by which a user selects, drags or drops an event button.

The communication unit 104 may be implemented as a communication module capable of using any one of all types of wired/wireless networks, such as a Local Area Network (LAN), a Wide Area Network (WAN), a Value Added Network (VAN), a Personal Area Network (PAN), a mobile radio communication network, the Wireless Broadband (Wibro) Internet, a Mobile Worldwide Interoperability for Microwave Access (mobile WiMAX) network, a High Speed Downlink Packet Access (HSDPA) network, and a satellite communication network.

The communication unit 104 may transmit and receive all data, essentially or additionally used to perform the schedule generation method, to and from another terminal or a server.

The location information unit 105 includes a module configured to acquire the location of the terminal 100. When the terminal 100 is movable, the location information unit 105 may collect geographical location information using a Global Position System (GPS) module. When the terminal 100 is not movable like a desktop computer, the location information unit 105 may collect Internet protocol addresses, and may identify the terminal 100 that is performing the schedule generation method.

The control unit 106 may control the operation of the terminal 100. For example, the control unit 106 may perform control so that the display unit 102 displays data stored in the memory unit 101, so that the communication unit 104 transmits data stored in the memory unit 101 to a server or another terminal 100, and so that the memory unit 101 stores data received via the communication unit 104. Furthermore, the control unit 106 may perform control so that user input received via the input unit 103 is processed and then the display unit 102 displays the user input or the memory unit 101 stores the user input.

Furthermore, the control unit 106 may output the period display region, stored in the memory unit 101, to the display unit 102. The “period display region” is a region in which a continuous period is visually represented, and refers to an image that is displayed on the display unit of the terminal. The period display region may be a table in which a continuous period has been divided into individual “intervals.” As a simple example, the period display region may be a calendar. The term “calendar” used below may be used as an embodiment of the period display region.

The term “interval” used herein refers to a unit by which the period display region is subdivided. For example, when the period display region represents one year, a single interval may be one month, one season, or a desired unit period shorter than the period display region. When the period display region represents one month, a single interval may be one week, one day, or a desired unit period shorter than one month. The term “day” used below is used as an embodiment of one interval by which a calendar is subdivided when the period display region is the calendar.

Furthermore, when the control unit 106 detects user input adapted to drag and drop the event button to and on one interval (e.g., a day) of the period display region (e.g., a calendar) via the input unit 103, event information corresponding to the dropped event button for the interval on which the event button has been dropped may be generated, and a display indicating that a schedule has been generated may be output after the generation of the event information.

In this case, the term “event button” is an icon representing (symbolizing) a specific event, and may be displayed on the display unit 102 of the terminal 100. For example, the event button represents an event, such as an exercise, an appointment, movie watching or the like, and may be represented in a text or image form.

In contrast, the event button may be an “empty event button” not presenting a specific event. Only an empty event button may be displayed on the display unit 102 of the terminal 100, and the empty event button may be included in a plurality of event buttons.

Furthermore, the control unit 106 receives user input adapted to designate a specific event for an empty event button, and may display the designated event in the empty event button. In the following, an empty event button filled by a user is referred to as a filled empty event button.

For this purpose, the control unit 106 may provide a user interface configured to fill an empty event button with a specific event in response to user input adapted to select an empty event button, and may provide an input means configured to input text or select an icon via the interface.

Furthermore, when the control unit 106 detects user input adapted to drag and drop a filled empty event button to and on one interval of the period display region via the input unit 103, the control unit 106 may generate event information corresponding to the event with which the empty event button has been filled for the interval on which the empty event button has been dropped.

According to an embodiment of the present invention shown in FIG. 3, when user input adapted to select the empty event button is received from a user, the control unit 106 may activate and output the user interface configured to enter an event in an empty event button. When the event “movie: Maze Runner release!” is received from a user and user input adapted to drag and drop an empty event button, with which the event “movie: Maze Runner release!” has been filled, to and on the “8th day” of a calendar is received from the user, the control unit 106 may generate event information corresponding to the event “movie: Maze Runner release!” on the “8th day” of the calendar.

As another embodiment of the present invention, the control unit 106 provides an interface configured to receive user input adapted to drag and drop an empty event button to and on the period display region and fill the empty event button.

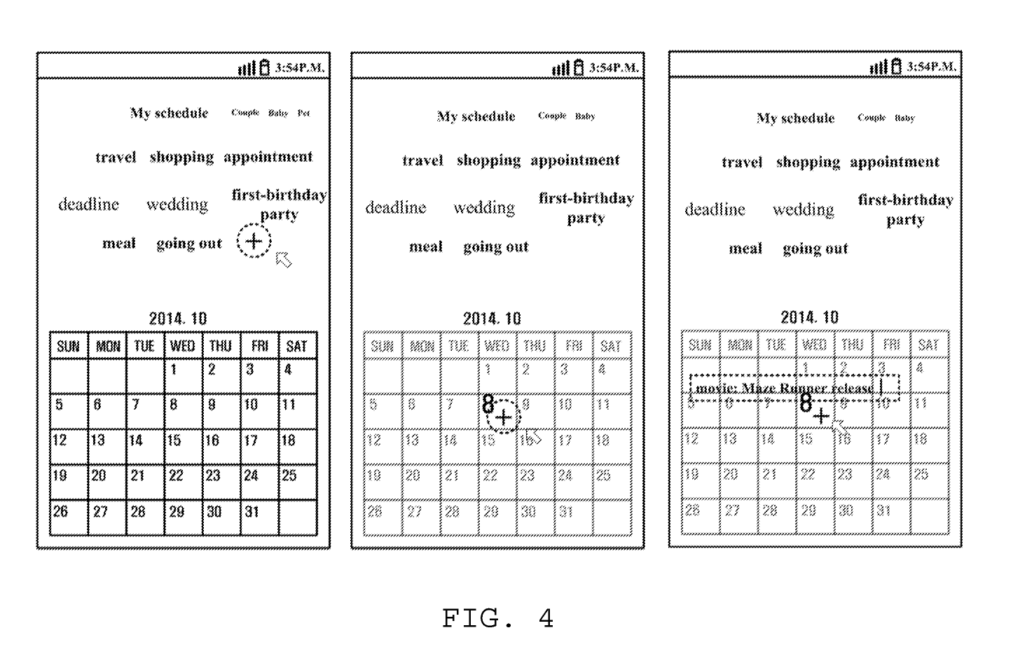

In an embodiment of the present invention shown in FIG. 4, when user input adapted to drag and drop an empty event button is received, the control unit 106 may activate the user interface configured to input an event, may receive an event from a user via the user interface, and may generate event information.

The term “event information” used herein refers to a record in which a user has designated a desired event for a desired period. The event information used herein may include all information related to a generated event, including not only the type of event which was generated by a user and a period for which the event was designated but also generation period-based event information including a period, a month and a season in which the event was generated, designated period-based event information including a period, a month and a season for which the event was designated, information about the location of a terminal when the event was generated, information about the identification of the terminal which was used when the event was generated, the Internet protocol of the terminal which was used when the event was generated, information about a place for which the event was designated, etc.

When the event button is superimposed on a desired interval of the period display region, the control unit 106 may change and output the interval. For example, the control unit 106 may change and output color, brightness, saturation, the size of a letter, and the size of the interval itself. This enables a user to accurately drop the event button on an intended interval.

The above-described schedule generation device according to the embodiment of the present invention provides an event icon list, including a plurality of icons corresponding to specific events, to a user, and enables an event to be generated by only input adapted to drag and drop an event icon, thereby significantly reducing the number of touches and input time that are required when a user selects a date and inputs an event in a text form in order to generate the event using a conventional schedule management application.

Meanwhile, the control unit 106 may provide an “event icon list” including a plurality of event buttons to a user. The “event icon list” refers to a group of multiple event buttons that are provided to a user. The control unit 106 may provide the event icon list, together with the period display region, to the user.

The control unit 106 may categorize a plurality of events according to desired criteria, and may generate a plurality of event icon lists corresponding to the categorized events. In the detailed description of the present invention, the things into which a plurality of events is categorized according to the desired criteria are referred to as “categories.” When a plurality of events is categorized according to desired criteria, each category includes a group of event buttons, i.e., an event icon list, corresponding to the categorized events.

As an embodiment of the present invention, an event icon list may assume a text cloud form or an image cloud form. The cloud form refers to a form in which event buttons are irregularly arranged and form a single group. However, the event icon list does not necessarily assume such a cloud form. For example, the event icon list may be implemented as a command-line interface or a menu-driven interface.

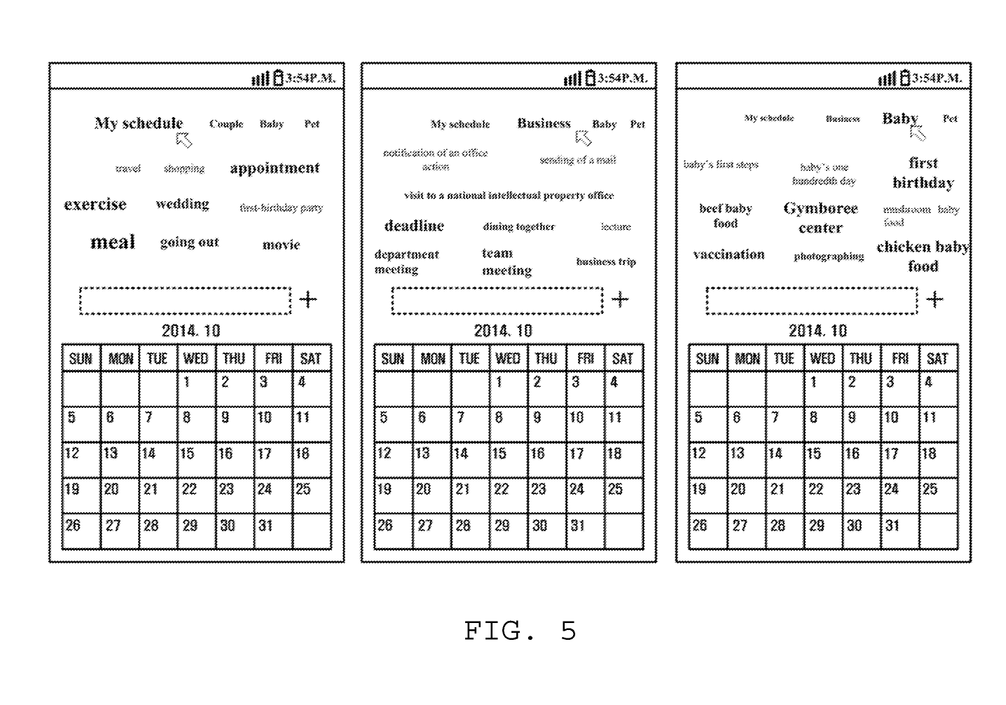

FIG. 5 shows an example in which the control unit 106 displays a plurality of event buttons for each category. The control unit 106 may categorize a plurality of events into categories, such as my schedule, business, baby categories, etc., according to desired criteria, and may display event buttons corresponding to the categorized events for each of the categories.

In this case, categories generally and commonly used may be set as default values and stored in the memory unit 101. For example, settings may be previously made and stored such that when a user selects the category “my schedule,” event buttons representing events, such as an appointment, an exercise, a meal, a wedding, going out and a movie, are displayed. In the case of the category “business,” settings may be previously made and stored such that event buttons representing events, such as a deadline, a team meeting and a visit to a national intellectual property office, are included.

Furthermore, the control unit 106 may provide an interface via which a user can generate or edit a category. A user may generate a new category, may eliminate an existing category, or may add or delete an event button to and from a category via the category generation or editing interface. Alternatively, an event button may be moved to another category as desired.

As an embodiment of the present invention, the event button addition interface may provide a means by which a user inputs text, thereby enabling the user to add an event button. As another embodiment, an event button may be added in such a manner as to present a plurality of icons to a user and receive user input adapted to select a desired icon among the plurality of icons.

Furthermore, the control unit 106 may count statistics regarding event information generated by user input, and may generate a user-customized category. For example, the control unit 106 may generate a few event buttons, having higher frequencies of use, into a single category based on the counted statistics.

Using this, the schedule generation terminal according to the embodiment of the present invention may categorize event icons corresponding to a specific schedule and may provide the categorized event icons to a user, thereby enabling the user to easily identify and select the various event icons.

As an embodiment of the present invention, the control unit 106 may count statistics regarding the day-of-the week-based, period-based, month-based or season-based frequencies of use by analyzing event information. A day-of-the week-based, period-based, month-based or season-based user-customized categories may be provided based on the statistics. As still another embodiment, the control unit 106 may analyze frequencies of use regarding the locations of the terminal 100, when events were set, in conjunction with the location information unit 105 of the terminal 100. For example, the frequencies of use of event buttons may be analyzed depending on whether the location of the terminal when events were generated was a company or a home, and user-customized categories may be generated for each case.

Alternatively, the control unit 106 may count statistics regarding the frequencies of use of the respective generated categories or the respective event buttons, and may change the sequence of the categories or may differently display colors or sizes based on the statistics. For example, a category having the highest frequency of use may be displayed first according to each condition. Alternatively, when the terminal for the generation of a schedule operates, a category having the highest frequency of use may be displayed on a first screen.

Alternatively, the sequence, colors or sizes of event buttons may be displayed differently based on the statistics. For example, an event button having a higher frequency of use may be displayed in a darker color or a larger size based on the statistics (see FIG. 5).

As an embodiment of the present invention, in the case of Tuesday, the control unit 106 may generate a category by collecting event buttons most frequently used on Tuesday, and may dispose the category on a first screen. Alternatively, the control unit 106 may generate a category by collecting event buttons most frequently used at the location of the terminal, and may dispose the category on a first screen.

Furthermore, the control unit 106 may share category data with another terminal 100 via the communication unit 104. The category data includes information about a list of event buttons that belong to the category. The sharing of the category data may be achieved by directly transmitting and receiving the category data between a plurality of terminals 100. Alternatively, the sharing of the category data may be achieved using a method in which a terminal 100 uploads the category data to a server and then another terminal 100 downloads and uses the category data. The sharing of the category data may aid family members, friends, people who love each other or company members in systematically managing schedules.

Furthermore, the control unit 106 may provide a “timeline,” which is a user interface that enables a period shorter than each interval of the period display region to be set. For example, when the period display region corresponds to a “month” and each interval of the period display region corresponds to a “day,” the timeline may be a user interface that enables a period unit, such as an “hour,” shorter than a “day” to be set.

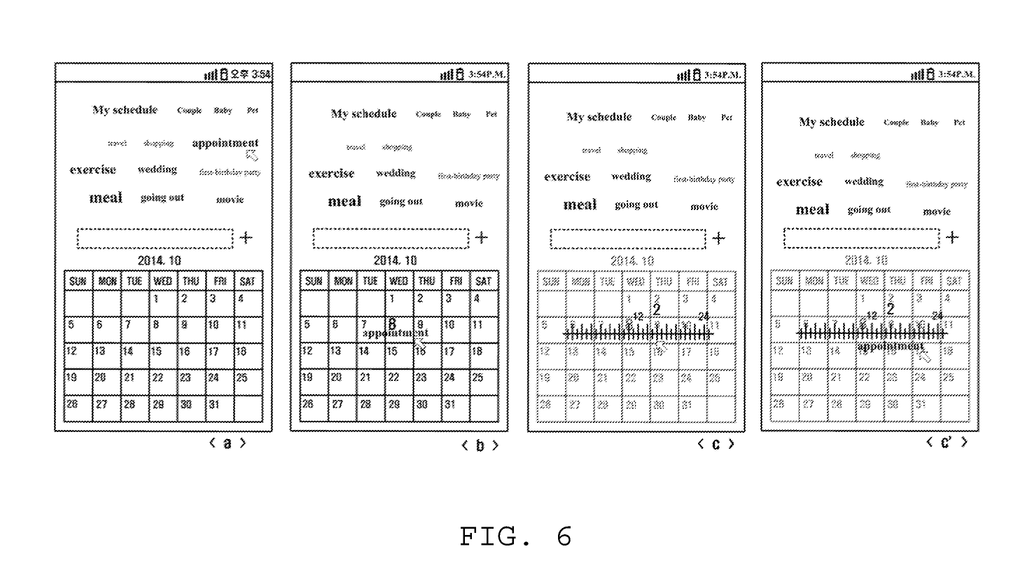

As an embodiment of the present invention, when an event button is dragged to and dropped on a desired interval of the period display region, the control unit 106 may output the timeline (see FIG. 6C). When user input adapted to select a desired region of the output timeline is received, event information including information corresponding to the selected region may be generated.

For example, when user input adapted to drag and drop an event button to and on a day region is received, the control unit 106 may output a timeline representing “hours.” When user input adapted to select a desired hour region on the timeline is received, the control unit may generate event information including the selected hour information.

As an embodiment of the present invention, the timeline may be provided to a user in the shape of a bar with which hours are marked. However, the timeline is not limited to the bar shape, but may have a circular shape or another shape. Hour spans may be distinguished from each other using graduations or colors.

As still another embodiment of the present invention, when a predetermined period has elapsed with an event button dragged to and superimposed on a desired interval, the control unit 106 may display the timeline (see FIG. 6C′). In this case, when the dragged event button is dropped on a desired region on the timeline, the control unit 106 may generate event information including hour information corresponding to the region on which the event button is dropped.

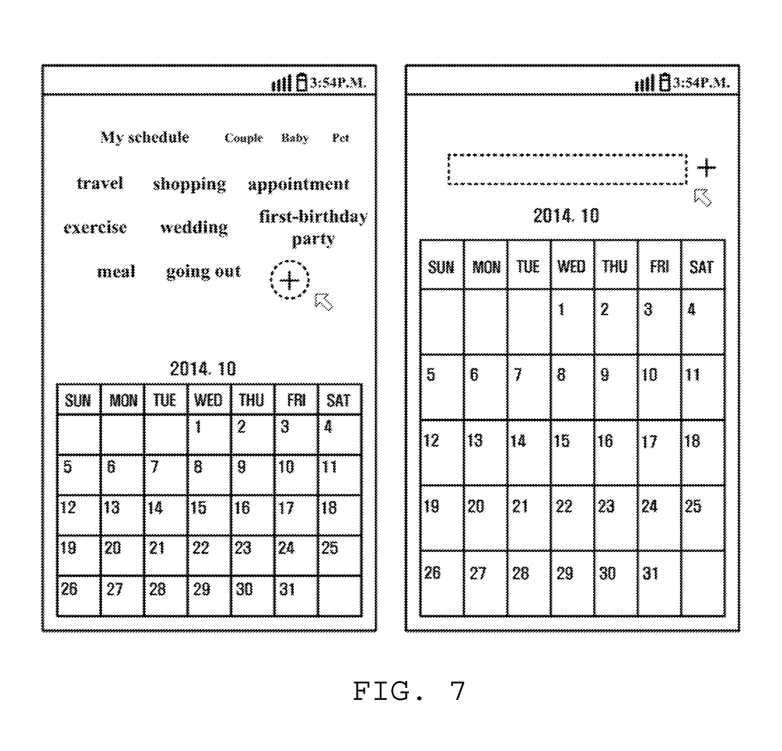

Referring to FIG. 7 as an embodiment of the present invention, the control unit may simultaneously display an event icon list, a period display region, and categories. However, according to user settings or another condition, the control unit may display only an empty event button and a calendar image without an event icon list.

Various embodiments presented in the detailed description of the present invention are implemented in the terminal 100 for a schedule generation method. The terminal 100 may be implemented using a computer, a mobile terminal, a television, a wearable device or the like that accesses a remote server over a network or that can be connected to another terminal and a server.

In this case, the computer includes, for example, a notebook computer, a desktop computer, a laptop computer, etc. on which a web browser has been installed. The mobile terminal is a wireless communication device capable of guaranteeing portability and mobility, and may include, for example, all types of handheld wireless communication devices, such as a Personal Communication System (PCS) terminal, a Personal Digital Cellular (PDC) terminal, a Personal Handyphone System (PHS) terminal, a Personal Digital Assistant (PDA), a Global System for Mobile communications (GSM) terminal, an International Mobile Telecommunication (IMT)-2000 terminal, a Code Division Multiple Access (CDMA)-2000 terminal, a W-Code Division Multiple Access (W-CDMA) terminal, a Wireless Broadband (Wibro) Internet terminal, a smartphone, and a Mobile Worldwide Interoperability for Microwave Access (mobile WiMAX) terminal.

Furthermore, the television may include an Internet Protocol Television (IPTV), an Internet Television (Internet TV), a terrestrial TV, a cable TV, etc. Furthermore, the wearable device is an information processing device that can be directly worn on a human body, such as a watch, glasses, an accessory, clothes, shoes, or the like, and may be connected to a remote server or another terminal over a network directly or via another information processing device.

A schedule generation program for the same user is not necessarily executed only on a single terminal 100.

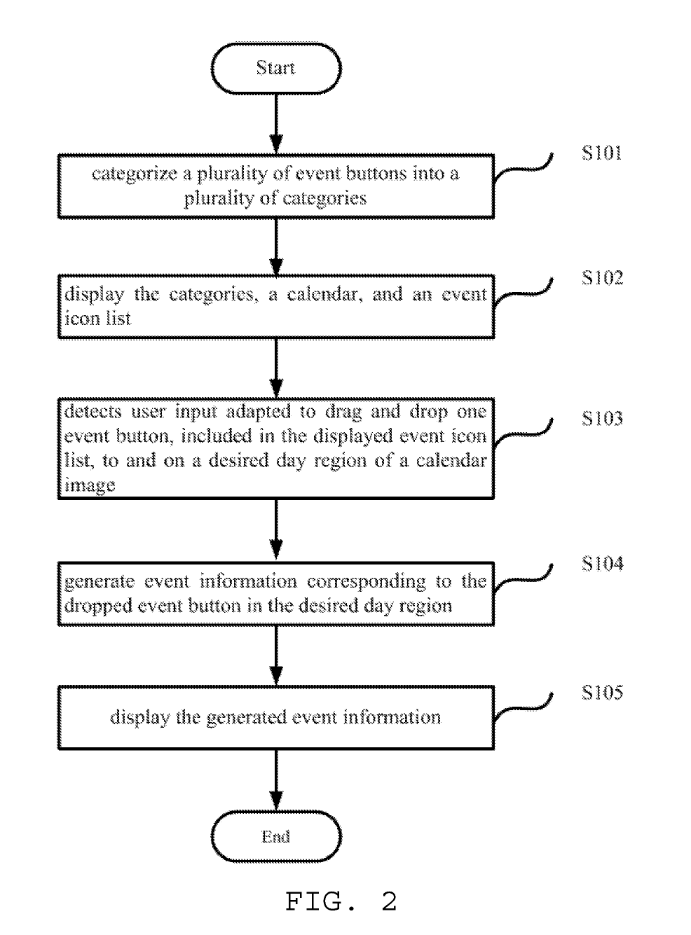

FIG. 2 is a flowchart of an embodiment of a schedule generation method that is performed by the terminal 100.

The schedule generation method according to the embodiment shown in FIG. 2 includes steps that are processed in a time series manner by the terminal 100 shown in FIG. 1. Accordingly, an item that is omitted in the following description but has been described in conjunction with the terminal 100 shown in FIG. 1 may be also applied to the schedule generation method according to the embodiment shown in FIG. 2.

The schedule generation method that is performed by the terminal 100 according to the embodiment of the present invention may include step S101 of categorizing a plurality of event buttons into a plurality of categories.

As embodiments of the present invention, step S101 may include the following four methods. The categorization of step S101 may be performed based on default values of an application that have been previously set. Alternatively, at step S101, the terminal 100 may categorize event buttons by receiving user input adapted to directly generate or edit categories. Alternatively, step S101 may be replaced with the step of receiving, by the terminal 100, a category list and an event button list, generated or edited by another user, from a server or another terminal. Alternatively, at step S101, the terminal 100 may generate and/or edit user-customized categories by analyzing event information generated by a user.

As an example of categorization, a plurality of event buttons may be categorized into a plurality of categories, such as a my schedule category, a business category and a baby category, according to desired criteria (see FIG. 5).

As an embodiment of the present invention, when the terminal 100 analyzes event information, the terminal 100 may count statistics regarding schedule generation conditions, including period-related information, such as a period, a day of the week, a month, or a season for which each event was set, location-related information, such as the location of the terminal when a corresponding event button was used, and other information related to the generated event. The terminal 100 may automatically categorize event buttons having higher frequencies of use into a single category for each of the schedule generation conditions, and may provide information about the category to a user.

The schedule generation method that is performed by the terminal 100 according to the embodiment of the present invention may include step S102 of displaying a list of event icons included in a category, a calendar and a desired category. In this case, the calendar is an embodiment of the period display region, and may be replaced with a period display region having another unit, such as a year, a week, or a day, representing a period.

The terminal 100 may display event buttons corresponding to the events, categorized at step S101, for each of the categories (see FIG. 5).

The terminal 100 may change the sequence of categories, to be provided to a user, based on the analysis of the event information. For example, when the schedule generation condition corresponds to “Tuesday,” an event button having the highest frequency of use on Tuesday may be presented on a first screen. An event button having the highest frequency of use at the location of the terminal may be presented on a first screen.

Step S102 may include the step of storing a calendar image, an event icon list image and a category image to be displayed. Although the storage of the images may be performed based on default values of an application that have been previously set, the images may be downloaded from a server or another terminal 100 and then stored. The storage is not necessarily performed within the terminal 100. For example, web storage that performs the storage function of the memory unit over the Internet may be used, in which case step S102 may include the step of downloading, by the terminal 100, images, to be displayed, from the web storage.

At step S102, the terminal 100 may display at least one of a category, a calendar and an event icon list. That is, all or some of the category, the calendar and the event icon list may be displayed. An empty event button may be included in the event icon list.

At step S102, although the terminal 100 may provide an event icon list in a tag cloud form or an icon cloud form, the event icon list does not necessarily need to be provided in a cloud form. For example, the event icon list may be implemented as a command-line interface or a menu-driven interface.

Step S102 may further include the step of receiving, by the terminal 100, user input adapted to select a category in response to user input, and the step of displaying, by the terminal 100, an event icon list corresponding to the category selected in response to the user input (see FIG. 5).

The schedule generation method that is performed by the terminal 100 according to the embodiment of the present invention may include step S103 of detecting user input adapted to drag and drop one of the event buttons, included in the displayed event icon list, to and on a desired day region of the calendar image. In this case, the day is an embodiment of the unit of intervals into which the period display region is subdivided. The day may be replaced with an interval having a unit shorter than the period display region, for example, a month for a year, a season for a year, an hour for a day, or a minute for an hour.

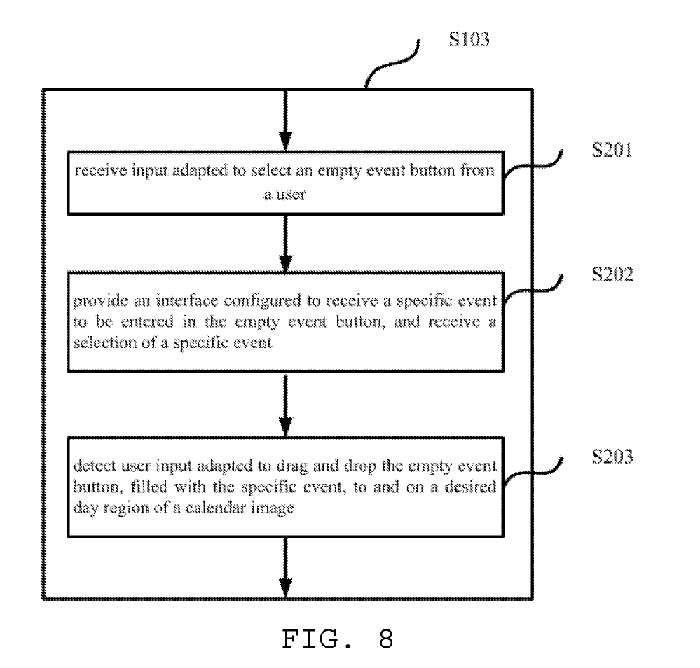

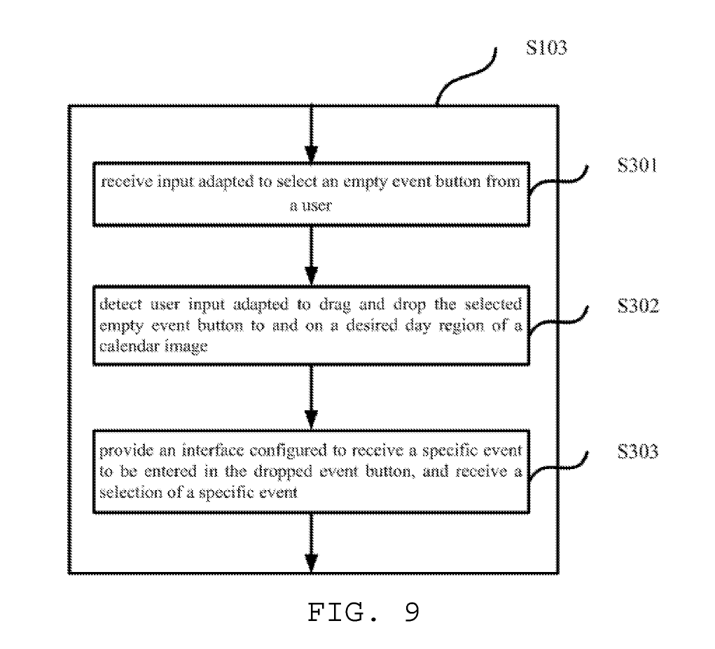

As an embodiment of step S103, step S103 may be performed using an empty event button for which an event has not been designated. In this case, the step of, when receiving input adapted to select the empty event button, providing, by the terminal, an interface that enables a user to directly designate an event may be further included. A detailed embodiment is described with reference to FIGS. 8 to 9.

Referring to FIG. 8, step S103 may include step S201 of receiving, by the terminal, input adapted to select an empty event button from a user. Step S103 may further include step S202 of providing a user interface that enables a specific event to be entered in the selected empty event button. At step S202, the user interface may be implemented as an interface that receives text from a user or that presents icons to a user and receives a selection of an icon from the user.

Furthermore, step S103 may further include step S203 of detecting user input adapted to drag and drop the empty event button, filled with a specific event by the reception of the user input via the user interface, to and on a desired day region of the calendar image.

Still another embodiment of step S103 of the schedule generation method according to the embodiment of the present invention is described with reference to FIG. 9. Step S103 may include step S301 of receiving input adapted to select an empty event button from a user. Step S103 may further include step S302 of detecting user input adapted to drag and drop the selected empty event button to and on a desired day region of a calendar image. Step S103 may further includes step S303 of providing a user interface that enables a specific event to be entered in the dropped event button and receiving user input adapted to select a specific event and fill the empty event button with the specific event via the user interface.

As an embodiment of step S103 of the schedule generation method according to the embodiment of the present invention, step S103 may further include the step of including the empty event button, filled through the above-described step, in a category.

As an embodiment of the present invention, step S104 may include the step of, when a predetermined period has elapsed with the event button dragged to and dropped on a desired day region or superimposed on a desired day region, displaying a timeline.

An embodiment of step S104 may include the step of, when receiving user input adapted to drag and drop an event button to and on a desired day region, displaying a timeline, and may further include the step of receiving user input adapted to select a desired time region on the timeline. Still another embodiment of step S104 may include the step of receiving user input adapted to drag an event button and superimpose the event button on a desired day region, and may include the step of, when a predetermined period has elapsed, displaying a timeline. The step of receiving user input adapted to drop the event button dragged to the desired time region on the timeline may be further included.

In this case, the timeline is an embodiment of an interface representing periods having a unit shorter than one interval. When one interval is a day, the timeline may represent hours or minutes. Alternatively, when one interval is a month, the timeline may be replaced with days or hours.

The schedule generation method according to the embodiment of the present invention may include step S104 of generating event information on the day on which the event button has been dropped. At step S104, when the terminal 100 receives user input adapted to select a desired time region on the timeline or user input adapted to drop an event button, the terminal 100 may generate event information including time information. At step S104, the terminal 100 may store the generated event information.

The schedule generation method according to the embodiment of the present invention may include step S105 of displaying the generated event information. The display of the event information at step S105 may be performed in a brief manner. In this case, step S105 may further include the step of, when receiving user input adapted to select event information display, displaying detailed event information in the form of a popup window or the like.

The schedule generation method according to the embodiment described in conjunction with FIG. 2 may be implemented in the form of a storage medium including computer-executable instructions, such as a computer-executable program module. The computer-readable medium may be a desired computer-accessible available medium, and includes all volatile and nonvolatile media and separable and non-separable media. Furthermore, the computer-readable medium may include all computer storage media and communication media. The computer storage medium includes volatile, nonvolatile, separable and non-separable media that are intended to store information, such as computer-readable instructions, a data structure, a program module or another type of data, and that is implemented using a desired method or technology. The communication medium typically includes computer-readable instructions, a data structure, a program module, or the data of a modulated data signal such as a carrier, or another type of transmission mechanism, and includes a desired information transfer medium.

Furthermore, the schedule generation method according to the embodiment of the present invention may be implemented as a computer program (or a computer program product) including computer-executable instructions. The computer program includes programmable machine instructions that are processed by a processor, and may be implemented as high-level programming language, object-oriented programming language, assembly language, machine language or the like. Furthermore, the computer program may be stored in a tangible computer-readable storage medium (for example, memory, a hard disk, a magnetic medium, an optical medium, a Solid-State Drive (SSD), or the like).

Accordingly, the schedule generation method according to the embodiment of the present invention may be implemented in such a manner that the above-described computer program is executed by a computing device. The computing device may include at least a part of a high-speed interface coupled to a processor, memory, a storage device, and memory and a high-speed extension port, and a low-speed interface coupled to a low-speed bus and a storage device. These components are coupled to each other using various buses, and may be mounted on a common mother board or may be mounted using another appropriate method.

In this case, the processor may process instructions within a computing device. These instructions are, for example, instructions that are stored in memory or a storage device in order to display graphic information adapted to provide a Graphic User Interface (GUI) onto an external input or output device, such as a display coupled to a high-speed interface. As another embodiment, a plurality of processors and/or a plurality of buses may be used along with a plurality of pieces of memory and a plurality of memory forms. Furthermore, the processor may be implemented as a chipset composed of chips including a plurality of independent analog and/or digital processors.

Furthermore, the memory stores information within a computing device. As an example, the memory may be composed of a volatile memory unit or a set of volatile memory units. As another example, the memory may be composed of a nonvolatile memory unit or a set of nonvolatile memory units. Furthermore, the memory may be, for example, another type of computer-readable medium, such as a magnetic or optical disk.

Furthermore, the storage device may provide a large amount of storage space to a computing device. The storage device may be a computer-readable medium or a configuration including such a medium. The storage device may include, for example, devices within a Storage Area Network (SAN) or another configuration. The storage device may be a floppy disk device, a hard disk device, an optical disk device, a tape device, flash memory, another similar semiconductor memory device, or a device array.

The above description of the present invention is intended merely for the purpose of illustration. It will be apparent to those having ordinary knowledge in the art to which the present invention pertains that the present invention can be easily modified in other specific forms without changing the technical spirit and essential features of the present invention.

Accordingly, the above-described embodiments are should be understood as being illustrates and not limitative in every aspect. For example, each component described as being in a single form may be practiced in a distributed form and, in the same manner, components described as being in a distributed form may be practiced in an integrated form.

The range of the present invention is defined by the following claims, rather than the detailed description. All variations and modifications derived from the meaning and scope of the claims and concepts equivalent thereto should be construed as being included in the range of the present invention.

What is claimed is:

1. A terminal for performing a schedule management method, the terminal comprising:
a display unit configured to display a user interface including a period display region, in which a continuous period is divided into intervals, and one or more event buttons;
an input unit configured to receive user input including a selection, a dragging or a dropping for the user interface that is displayed by the display unit; and
a control unit configured to, when receiving user input adapted to select a part of the event buttons via the input unit and drag and drop the selected event button on a desired interval of the period display region, generate event information corresponding to the selected event button for the desired interval.

2. The terminal of claim 1, wherein:
the control unit generates categories by categorizing one or more events according to desired criteria; and
the display unit displays event buttons corresponding to categorized events for each of the categories.

3. The terminal of claim 2, wherein the control unit receives user input adapted to edit the categories, and generates user-customized categories.

4. The terminal of claim 2, wherein the control unit counts statistics regarding frequencies of use of the respective event buttons, and generates user-customized categories based on the statistics.

5. The terminal of claim 2, wherein:
the control unit counts statistics regarding frequencies of use of the respective categories or event buttons; and
the display unit changes a sequence of the categories or event buttons, or differently displays colors and sizes of the categories or event buttons.

6. The terminal of claim 2, further comprising a communication unit configured to transmit and receive data about the categories, generated by the control unit, to and from a server or another terminal.

7. The terminal of claim 1, wherein:
the display unit displays an empty event button for which a specific event has not been designated, and a user interface which receives a desired event, to be entered in the empty event button, from a user; and
the control unit generates information about the received event to be entered in the empty event button for the desired interval.

8. The terminal of claim 1, wherein the control unit displays a timeline, in which one interval of the period display region is subdivided and represented, when the event button is dragged to, or dragged to and dropped on a desired interval, and generates event information further including time information corresponding to a selected desired region when user input adapted to select the desired region on the timeline is received.

9. A schedule generation method by which a terminal performs schedule management, the schedule generation method comprising:
generating one or more categories by categorizing one or more event buttons according to desired criteria;
displaying a period display region, in which a continuous period is divided into intervals, and the categories;
receiving user input adapted to drag and drop a desired one of the one or more event buttons to and on a desired interval of the period display region; and
generating event information corresponding to the event button dropped on the desired interval.

10. The method of claim 9, wherein generating the one or more categories comprises at least one of:
receiving user input adapted to edit the categories, and generating user-customized categories; and
counting statistics regarding frequencies of use of the respective event buttons, and generating user-customized categories based on the statistics.

11. The method of claim 9,
further comprising counting statistics regarding frequencies of use of the respective categories or event buttons; and
further comprising at least one of:
changing a display sequence of the categories or event buttons; and
differently displaying colors and sizes of the categories or event buttons.

12. The method of claim 9, further comprising transmitting and receiving data about the generated categories to and from a server or another terminal.

13. A schedule generation method by which a terminal performs schedule management, the schedule generation method comprising:
providing a period display region in which a continuous period is divided into intervals, and a user interface which enables a user to enter a desired event in an empty event button;
receiving the desired event for the empty event button from the user via the user interface;
receiving user input adapted to drag and drop the empty event button to and on a desired interval of the period display region; and
generating information about the received event in the empty event button for the desired interval.

14. The method of claim 9, further comprising any one of:
displaying a timeline, in which one interval of the period display region is subdivided and represented, when the event button is dragged to and dropped on a desired interval; and
displaying a timeline, in which one interval of the period display region is subdivided and represented, when a predetermined period has elapsed with the event button superimposed on a desired interval of the period display region.

15. A computer program stored in a storage medium to perform the method set forth in claim 9.
